(19) United States
(12) Patent Application Publication
(10) Pub. No.: US 2024/0328117 A1
(43) Pub. Date: Oct. 3, 2024

(54) HYDRAULIC SYSTEM OF WORKING MACHINE AND WORKING MACHINE

(71) Applicant: KUBOTA CORPORATION, Osaka (JP)

(72) Inventors: Hiroshi HORII, Osaka (JP); Hiroya MORI, Osaka (JP)

(73) Assignee: KUBOTA CORPORATION, Osaka (JP)

(21) Appl. No.: 18/738,248

(22) Filed: Jun. 10, 2024

Related U.S. Application Data
(63) Continuation of application No. PCT/JP2022/041050, filed on Nov. 2, 2022.

(30) Foreign Application Priority Data
Dec. 28, 2021 (JP) 2021-214937

(51) Int. Cl. E02F 9/22; F15B 13/04; F15B 13/044

(52) U.S. Cl. CPC E02F 9/2203; E02F 9/2285; F15B 13/0401; F15B 13/044; E02F 9/2292; E02F 9/2296; F15B 2211/327

(57) ABSTRACT

A hydraulic system of a working machine includes a hydraulic actuator to be driven by a hydraulic fluid, a control valve to perform a switching operation for switching a flow rate of the hydraulic fluid supplied to the hydraulic actuator, and a controller to control the control valve. The control valve includes a solenoid and performs the switching operation in accordance with a current supplied to the solenoid. The controller supplies, to the solenoid, a shift current for causing the control valve to perform the switching operation and intermittently supplies a standby current when the shift current is not supplied, the standby current having a current value smaller than the shift current and within a range in which the control valve does not perform the switching operation.

### CROSS REFERENCE TO RELATED APPLICATIONS

This application is a continuation application of International Application No. PCT/JP2022/041050, filed on Nov. 2, 2022, which claims the benefit of priority to Japanese Patent Application No. 2021-214937, filed on Dec. 28, 2021. The entire contents of each of these applications are hereby incorporated herein by reference.

### BACKGROUND OF THE INVENTION

### 1. Field of the Invention

The present invention relates to a hydraulic system of a working machine, such as a slewable excavator (a backhoe), and a working machine.

### 2. Description of the Related Art

In the related art, a working machine, such as a slewable excavator (a backhoe), disclosed in Japanese Unexamined Patent Application Publication No. 2018-188825 is known as an example of a working machine that includes a hydraulic system. A hydraulic system of the working machine disclosed in Japanese Unexamined Patent Application Publication No. 2018-188825 includes a hydraulic actuator, a solenoid control valve that controls the flow rate of a hydraulic fluid supplied to the hydraulic actuator, an operation member that is operated by an operator, and a controller that controls the value of a solenoid energizing current supplied to the solenoid control valve in accordance with an operation amount of the operation member.

### SUMMARY OF THE INVENTION

In the working machine of Japanese Unexamined Patent Application Publication No. 2018-188825, the controller can operate the hydraulic actuator by controlling the solenoid control valve in accordance with the operation amount of the operation member. However, in low-temperature conditions, such as in cold regions, the temperature of the hydraulic fluid becomes low, causing an increase in the viscosity resistance of the hydraulic fluid. Thus, there is a problem in that it takes time for the position of the solenoid control valve to be changed such that the supply state of the hydraulic fluid supplied to the hydraulic actuator is switched after the operation member has been operated and a solenoid of the solenoid control valve has been energized, that is, a delay in response occurs. Therefore, supplying a weak current beforehand while a solenoid proportional valve is in a non-operating state may be considered in order to improve the response when the solenoid proportional valve is switched thereafter.

However, when such a current is constantly supplied to the solenoid proportional valve in the non-operating state, there is a problem of increased power consumption, and also there is a problem in that a large load is applied to the controller and the like.

The present invention has been made to solve such problems of the related art, and it is an object of the present invention to suppress a delay in response of a solenoid proportional valve without an excessive increase in power consumption.

### Solution to Problem

A hydraulic system of a working machine according to an aspect of the present invention includes a hydraulic actuator to be driven by a hydraulic fluid, a control valve to perform a switching operation for switching a flow rate of a hydraulic fluid supplied to the hydraulic actuator, and a controller to control the control valve. The control valve includes a solenoid and performs the switching operation in accordance with a current supplied to the solenoid. The controller supplies, to the solenoid, a shift current for causing the control valve to perform the switching operation and intermittently supplies a standby current when the shift current is not supplied, the standby current having a current value smaller than the shift current and within a range in which the control valve does not perform the switching operation.

The hydraulic system of a working machine may include a plurality of the hydraulic actuators and a plurality of the control valves each corresponding to one of the plurality of hydraulic actuators. The controller may supply the standby current to a plurality of the solenoids of the plurality of control valves at different timings.

The control valve may include a directional switching valve to switch a flow rate of a hydraulic fluid supplied to the hydraulic actuator and a solenoid proportional valve including the solenoid, the solenoid being configured to cause, in accordance with the shift current, the directional switching valve to operate.

The solenoid of the control valve may include a first solenoid to act on switching of the control valve to one side and a second solenoid to act on switching of the control valve to another side. The controller may intermittently supply the standby current to one of the first solenoid and the second solenoid that is not supplied with the shift current.

The controller may supply the standby current to the first solenoid and the second solenoid in the control valve simultaneously when neither the first solenoid nor the second solenoid is supplied with the shift current.

The controller may supply the standby current to the first solenoid and the second solenoid in the control valve at different timings when neither the first solenoid nor the second solenoid is supplied with the shift current.

The control valve may include a directional switching valve including a first pressure receiver and a second pressure receiver, the directional switching valve being configured to perform the switching operation in accordance with a pilot pressure acting on the first pressure receiver and the second pressure receiver, and a solenoid proportional valve including a first proportional valve to control, by operation of the first solenoid, a pilot pressure acting on the first pressure receiver and a second proportional valve to control, by operation of the second solenoid, a pilot pressure acting on the second pressure receiver. The controller may intermittently supply the standby current to one of the first proportional valve and the second proportional valve that does not supply a pilot pressure for causing the directional switching valve to perform the switching operation.

A working machine may include the above-described hydraulic system.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view of an excavator (a backhoe) as an example of a working machine.

FIG. 2 is a schematic view of a hydraulic system of the working machine that drives various hydraulic actuators in a first embodiment.

FIG. 3 is a hydraulic circuit diagram relating to a boom control valve, an arm control valve, a bucket control valve, and a turn control valve in the first embodiment.

FIG. 4 is a hydraulic circuit diagram relating to a dozer control valve, a swing control valve, a first travel control valve, a second travel control valve, and an SP control valve in the first embodiment.

FIG. 5 is a diagram illustrating a standby current that is supplied to a solenoid proportional valve (a solenoid) by a controller.

FIG. 6A is a time chart illustrating an example of a pattern relating to a timing at which the controller supplies the standby current to each solenoid proportional valve (each solenoid).

FIG. 6B is a time chart illustrating an example of a pattern relating to a timing at which the controller supplies the standby current to the solenoid proportional valves (solenoids) of the plurality of control valves.

FIG. 6C is a time chart illustrating another example of the pattern relating to the timing at which the controller supplies the standby current to the solenoid proportional valves (solenoids) of the plurality of control valves.

FIG. 7 is a schematic view of a hydraulic system of a working machine that drives various hydraulic actuators in a second embodiment.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

An embodiment of the present invention will be described below with reference to the drawings as necessary.

### FIRST EMBODIMENT

### Overall Configuration

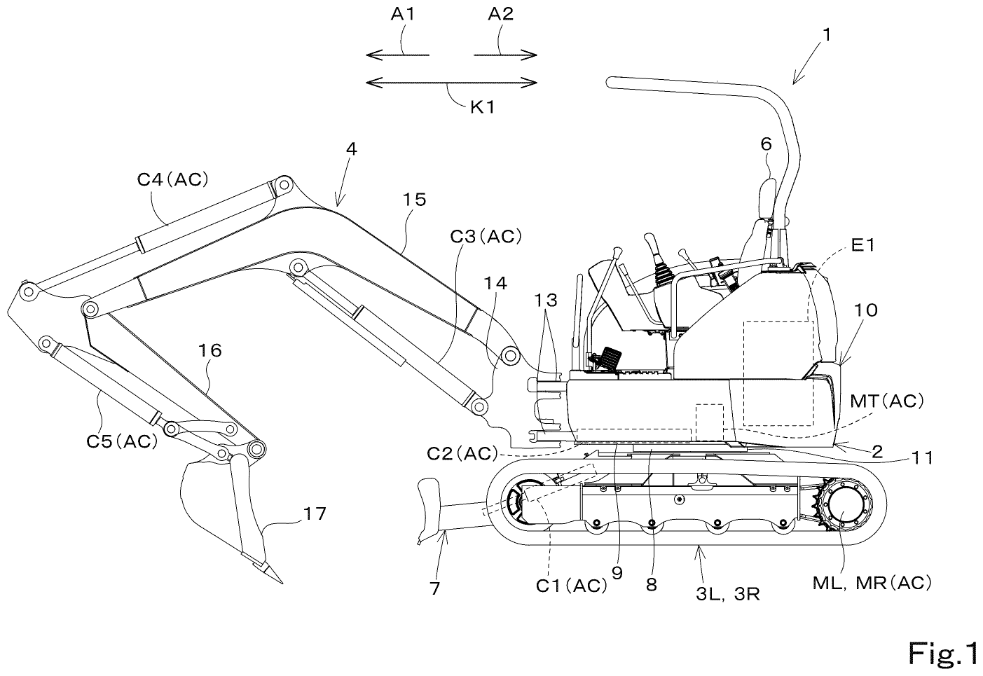

FIG. 1 is a side view illustrating the overall configuration of a working machine 1. In the present embodiment, an excavator (a backhoe) that is a slewable working machine is described as an example of the working machine 1.

As illustrated in FIG. 1, the working machine 1 includes a machine body (a slewing base) 2, a left traveling device 3L that is disposed on the left of the machine body 2, a right traveling device 3R that is disposed on the right of the machine body 2, and a working device 4 that is attached to a front portion of the machine body 2. An operator's seat 6 where a driver (an operator) sits is provided on the machine body 2.

In the present embodiment, a direction corresponding to the direction in which the driver in the operator's seat 6 of the working machine 1 faces (the direction of arrow Al in FIG. 1) will be defined as a front direction of the working machine 1, and a direction (the direction of arrow A2 in FIG. 1) that is opposite to the front direction will be defined as a rear direction. In addition, a left direction of the working machine 1 corresponds to a direction toward the left side of the driver facing forward along arrow A1 (a direction toward the near side in FIG. 1).

Accordingly, directions K1 in FIG. 1 are the front and rear directions (the longitudinal direction of the machine body). In addition, the horizontal direction that is a direction perpendicular to the front and rear directions K1 will be referred to as a machine-body width direction (including the left and right directions).

In the present embodiment, the left traveling device 3L and the right traveling device 3R are formed of crawler-type traveling devices. The left traveling device 3L is driven by a traveling motor ML, and the right traveling device 3R is driven by a traveling motor MR.

Each of the traveling motors ML and MR is a hydraulic motor. A dozer 7 is mounted on a front portion of a traveling frame 11 on which the left traveling device 3L and the right traveling device 3R are mounted. The dozer 7 includes a blade that is raised and lowered by expansion and contraction of a dozer cylinder C1.

The machine body 2 is supported on the traveling frame 11 with a slewing bearing 8 interposed therebetween such that the machine body 2 is turnable around an axis that extends in the vertical direction (hereinafter referred to as a “vertical axis”). The machine body 2 is driven so as to turn by a slewing motor MT, which is another hydraulic motor (at least one hydraulic actuator AC).

The machine body 2 includes a slewing board 9 that turns around the vertical axis and a weight 10 that is supported at a rear portion of the slewing board 9. The slewing board 9 is formed of a steel plate or the like and is connected to the slewing bearing 8. A prime mover El is mounted on a rear portion of the machine body 2.

In the present embodiment, the prime mover E1 is an engine. Note that the prime mover E1 may be an electric motor or may be a hybrid power system including an engine and an electric motor.

The machine body 2 includes a support bracket 13 provided at the front portion thereof. A swing bracket 14 is attached to the support bracket 13 so as to be swingable around a vertical axis. The working device 4 is attached to the swing bracket 14.

The working device 4 includes a boom 15, an arm 16, and a bucket 17 that serves as a working tool. The boom 15 is attached to the swing bracket 14 at its base portion such that the boom 15 is pivotable around an axis (hereinafter referred to as a “horizontal axis”) that extends in the machine-body width direction, and an end portion of the boom 15 is capable of swinging in the vertical direction. The arm 16 is attached to the end portion of the boom 15 at its base portion such that the arm 16 is pivotable around a horizontal axis, and an end portion of the arm 16 is capable of swinging in the front and rear directions K1 or in the vertical direction.

The bucket 17 is provided at the end portion of the arm 16 so as to be capable of performing a shoveling operation and a dumping operation. The shoveling operation of the bucket 17 is a swing in a direction toward the boom 15 with respect to the end portion of the arm 16, and the dumping operation of the bucket 17 is a swing in a direction away from the boom 15 with respect to the end portion of the arm 16.

Instead of the bucket 17 or in addition to the bucket 17, another working tool that is a hydraulic attachment which can be driven by at least one hydraulic actuator AC can be attached to the working machine 1.

Expansion and contraction of a swing cylinder C2 that is included in the machine body 2 enables the swing bracket 14 to swing. Expansion and contraction of a boom cylinder C3 enables the boom 15 to swing. Expansion and contraction of an arm cylinder C4 enables the arm 16 to swing.

Expansion and contraction of a bucket cylinder C5, which serves as a working-tool cylinder, enables the bucket 17 to perform the shoveling operation and the dumping operation. The shoveling operation is a movement of the bucket 17 in the direction toward the boom 15 with respect to the arm 16, and the dumping operation is a movement of the bucket 17 in the direction away from the boom 15 with respect to the arm 16.

The dozer cylinder C1, the swing cylinder C2, the boom cylinder C3, the arm cylinder C4, and the bucket cylinder C5 are hydraulic cylinders (hydraulic actuators AC).

As described above, the working machine 1 includes the plurality of hydraulic actuators AC. The plurality of hydraulic actuators AC includes the hydraulic motors serving as the traveling motors ML and MR, and the slewing motor MT, and the hydraulic cylinders serving as the dozer cylinder C1, the swing cylinder C2, the boom cylinder C3, the arm cylinder C4, and the bucket cylinder C5.

### Hydraulic System of Working Machine

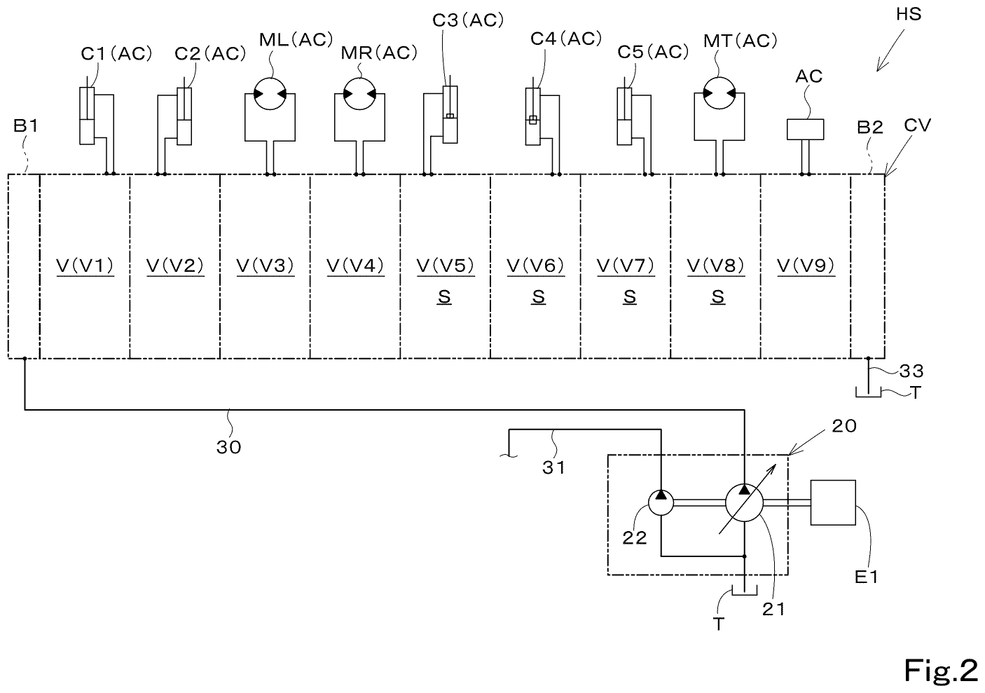

FIG. 2 illustrates a schematic configuration of a hydraulic system HS of the working machine 1 for actuating the plurality of hydraulic actuators AC (MT, ML, MR, C1 to C5), which are included in the working machine 1 as mentioned above. As illustrated in FIG. 2, the hydraulic system HS of the working machine 1 includes a pressure-oil supply unit 20 and a control valve unit CV.

The pressure-oil supply unit 20 is provided with a first pump 21 that is a main pump to supply a hydraulic fluid for actuating the hydraulic actuators AC and a second pump 22 that is a pilot pump for supplying a signal pressure oil as a pilot pressure, a detection signal, or the like.

The first pump 21 and the second pump 22 are driven by the prime mover El. The first pump 21 is a variable displacement hydraulic pump, and the second pump 22 is a fixed-displacement hydraulic pump. The first pump 21 is, for example, a swash-plate axial pump that is capable of changing a delivery amount by changing the angle of a swash plate, and the second pump 22 is, for example, a gear pump. Note that, in the following description, the second pump 22 will sometimes be referred to as a “hydraulic pump”.

The control valve unit CV is a unit in which a plurality of control valves V (V1 to V9), an inlet block B1, and an outlet block B2 are arranged in a row or in a stacked manner, coupled to each other, and connected to each other by an internal fluid passage. The plurality of control valves V (V1 to V9) control the various hydraulic actuators AC (MT, ML, MR, C1 to C5), each of which is driven by the hydraulic fluid. The plurality of control valves V can perform a switching operation for switching the flow rate of the hydraulic fluid supplied to the hydraulic actuators AC.

Note that the plurality of control valves V do not need to be combined as the control valve unit CV and may be arranged separately in the working machine 1 and may be connected to each other by an external fluid passage.

As illustrated in FIG. 2, the hydraulic system HS of the working machine 1 includes a delivery fluid passage 30 and a supply fluid passage 31. The delivery fluid passage 30 is a fluid passage that connects the first pump 21 and the inlet block B1 to each other. Accordingly, a fluid delivered from the first pump 21 is supplied to the inlet block B1 through the delivery fluid passage 30 and then supplied to each of the control valves V (V1 to V9).

The supply fluid passage 31 is a fluid passage that is connected to the second pump 22 and is a fluid passage through which a hydraulic fluid delivered from the second pump 22 (a delivered fluid) flows. In other words, the delivered fluid is supplied as a primary pilot pressure to a primary side of the control valves V through the supply fluid passage 31.

Thus, each of the plurality of control valves V can switch, by changing a switching position, the delivery (supply) amount (output) of the hydraulic fluid supplied from the delivery fluid passage 30 to the corresponding hydraulic actuator AC and the delivery (supply) direction of the hydraulic fluid.

As illustrated in FIG. 2, the control valves V include a dozer control valve V1 that controls the dozer cylinder C1, a swing control valve V2 that controls the swing cylinder C2, a first travel control valve V3 that controls the traveling motor ML of the left traveling device 3L, a second travel control valve V4 that controls the traveling motor MR of the right traveling device 3R, a boom control valve V5 that controls the boom cylinder C3, an arm control valve V6 that controls the arm cylinder C4, a bucket control valve V7 that controls the bucket cylinder C5, a turn control valve V8 that controls the slewing motor MT, and an SP control valve V9 that controls the hydraulic actuators AC included in a hydraulic attachment in the case where the hydraulic attachment is attached as a working tool.

Note that, although FIG. 2 illustrates a case in which the plurality of control valves V include the SP control valve V9, a configuration that does not include the SP control valve V9 may be employed.

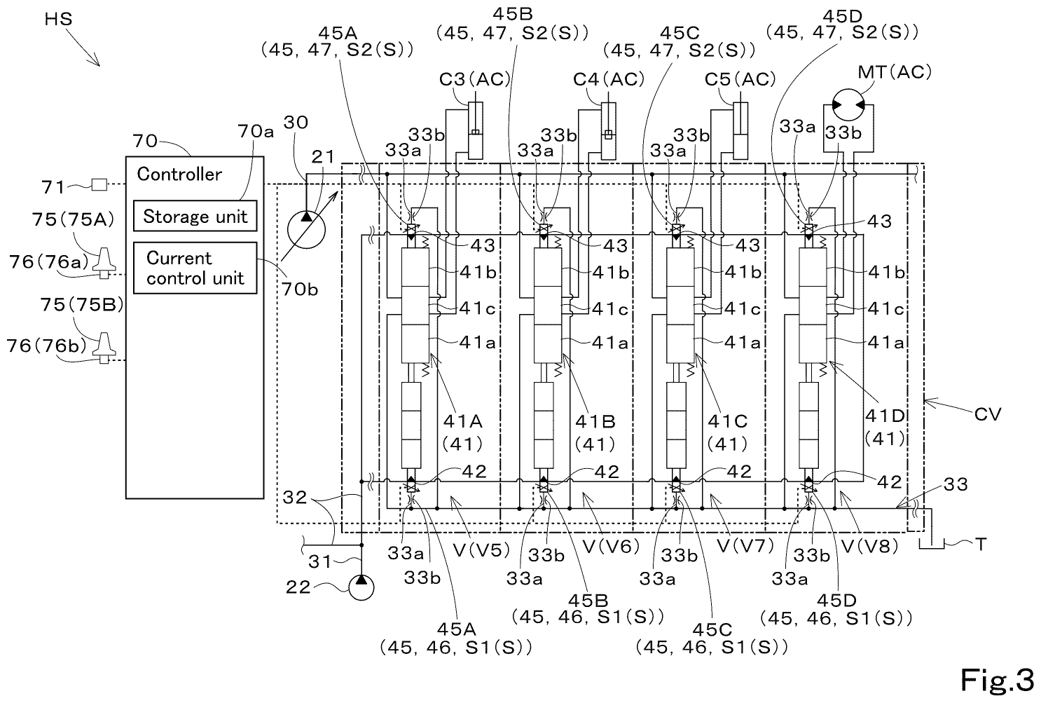

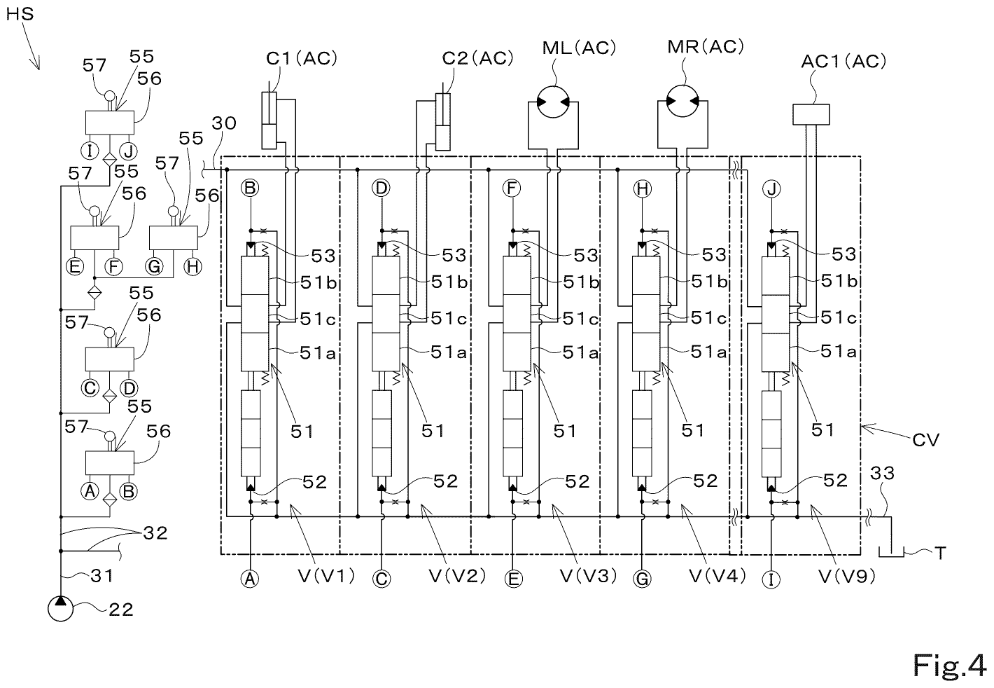

As illustrated in FIG. 3 and FIG. 4, the plurality of control valves V for controlling their respective hydraulic actuators AC in the control valve unit CV of the present embodiment each have a spool and each constitute a three-position directional switching valve that can be switched to three positions in response to movement of the spool. Note that each of the plurality of control valves V may be a two-position switching valve, a four-position switching valve, or the like other than the three-position switching valve, and the number of switching positions is not limited.

Among the plurality of control valves V as the three-position directional switching valves, some of the control valves V are combinations of directional switching valves 41 and pilot-operated solenoid proportional valves 45 as illustrated in FIG. 3. The other control valves V are non-solenoid, pilot-operated switching valves 51 as illustrated in FIG. 4.

The control valves V including the solenoid proportional valves 45 and that are illustrated in FIG. 3 will be described below. These are the boom control valve V5, the arm control valve V6, the bucket control valve V7, and the turn control valve V8, and they form a hydraulic circuit such as that illustrated in FIG. 3.

Each of the control valves V (V5, V6, V7, V8) illustrated in FIG. 3 includes the three-position directional switching valve 41 that switches positions in response to the movement of the spool caused by the pilot pressure of the hydraulic fluid. The directional switching valve 41 controls the operation of the corresponding hydraulic actuator AC by changing the flow rate of the hydraulic fluid supplied to the hydraulic actuator AC.

In addition, each of the control valves V (V5, V6, V7, V8) illustrated in FIG. 3 includes a pair of solenoid proportional valves 45 for controlling the switching positions of the directional switching valve 41. The solenoid proportional valves 45 include solenoids S, and each of the solenoids S is energized in response to a current being supplied thereto, so that the corresponding directional switching valve 41 performs an operation (a switching operation). In other words, a first proportional valve 46 that serves as one of the solenoid proportional valves 45 is disposed on a first side of each of the directional switching valves 41 in movement directions of the spool, and a second proportional valve 47 that serves as another one of the solenoid proportional valves 45 is disposed on a second side of each of the directional switching valves 41. As a result of these proportional valves opening and closing, the hydraulic fluid with the pilot pressure is supplied to the spools, so that the spools are moved such that the switching positions of the directional switching valves 41 are changed.

Note that, in the following description, the directional switching valve 41 that is included in the boom control valve V5 will be referred to as a first switching valve 41A, and the directional switching valve 41 that is included in the arm control valve V6 will be referred to as a second switching valve 41B. The directional switching valve 41 that is included in the bucket control valve V7 will be referred to as a third switching valve 41C, and the directional switching valve 41 that is included in the turn control valve V8 will be referred to as a fourth switching valve 41D. The term “directional switching valves 41” represents a collective name for the first switching valve 41A to the fourth switching valve 41D.

In the following description, the solenoid proportional valves 45 that are included in the boom control valve V5 will be referred to as first solenoid valves 45A, and the solenoid proportional valves 45 that are included in the arm control valve V6 will be referred to as second solenoid valves 45B. The solenoid proportional valves 45 that are included in the bucket control valve V7 will be referred to as third solenoid valves 45C, and the solenoid proportional valves 45 that are included in the turn control valve V8 will be referred to as fourth solenoid valves 45D. The term “solenoid proportional valves 45” represents a collective name for the first solenoid valves 45A to the fourth solenoid valves 45D.

Each of the directional switching valves 41 is switchable among a first position 41a, a second position 41b, and a neutral position 41c. Each of the directional switching valves 41 is urged so as to be at the neutral position 41c by an urging force of a neutral spring on the first side in position switching directions (the moving directions of the spool) and an urging force of another neutral spring on the second side opposite to the first side and is switched from the neutral position 41c to the first position 41a or the second position 41b by the pilot pressure of the hydraulic fluid supplied from the first proportional valve 46 or the second proportional valve 47, which is one of the solenoid proportional valves 45.

Each of the directional switching valves 41 includes a first pressure receiver 42 provided on the first side and a second pressure receiver 43 on the second side in the position switching directions (the moving directions of the spool). When the pilot pressure of the hydraulic fluid supplied from the first proportional valve 46 acts on the first pressure receiver 42, the directional switching valve 41 is switched from the neutral position 41c to the first position 41a. When the pilot pressure of the hydraulic fluid supplied from the second proportional valve 47 acts on the second pressure receiver 43, the directional switching valve 41 is switched from the neutral position 41c to the second position 41b.

Thus, each of the directional switching valves 41 can switch the delivery (supply) amount (output) of the hydraulic fluid supplied from the delivery fluid passage 30 to the corresponding hydraulic actuator AC and the delivery (supply) direction of the hydraulic fluid.

The solenoid proportional valves 45 are each capable of changing the pilot pressure as a result of a current being supplied thereto, causing the solenoid S to be energized. Note that the current supplied to the solenoid proportional valve 45 has a dither amplitude. This dither amplitude causes the solenoid S to perform minute movement, so that the hydraulic fluid that acts on the pressure receiver(s) 42 and/or 43 of the corresponding directional switching valve 41 from the solenoid proportional valve 45 also pulsates.

In each of the control valves V illustrated in FIG. 3, the first proportional valve 46 (one of the solenoid proportional valves 45) supplies the hydraulic fluid to the first pressure receiver 42 of the directional switching valve 41, and the second proportional valve 47 (the other solenoid proportional valve 45) supplies the hydraulic fluid to the second pressure receiver 43 of the directional switching valve 41, which is provided on the side opposite to the first pressure receiver 42. The hydraulic fluid delivered from the second pump 22 is supplied to the first proportional valve 46 and the second proportional valve 47 through the supply fluid passage 31.

The first proportional valve 46 and the second proportional valve 47 each have the solenoid S and are each opened by energization of the corresponding solenoid S so as to supply the hydraulic fluid to a corresponding one of the first and second pressure receivers 42 and 43 of the directional switching valve 41, and the spool is moved by receiving the pilot pressure of the hydraulic fluid, so that the switching positions of the directional switching valve 41 are controlled.

Note that the solenoid S of the first proportional valve 46 will be referred to as a first solenoid S1, and the solenoid S of the second proportional valve 47 will be referred to as a second solenoid S2. In addition, regardless of the presence or absence of the proportional valves 46 and 47, the solenoid that acts on switching of the spool to the first side may sometimes be referred to as the first solenoid S1, and the solenoid that acts on switching of the spool to the second side may sometimes be referred to as the second solenoid S2. In other words, the first proportional valve 46 includes the solenoid S (first solenoid S1) and controls the pilot pressure that acts on the first pressure receiver 42 by operation of the first solenoid S1. The second proportional valve 47 includes the solenoid S (second solenoid S2) and controls the pilot pressure that acts on the second pressure receiver 43 by operation of the second solenoid S2.

More specifically, the hydraulic system HS of the working machine 1 includes a hydraulic fluid passage 32 that is connected to the supply fluid passage 31 and a drain fluid passage 33 that is connected to a hydraulic fluid tank T.

A first end portion of the hydraulic fluid passage 32 is connected to the supply fluid passage 31, and a second end portion of the hydraulic fluid passage 32 on the opposite side of the first end portion is branched into a plurality of portions and connected to ports on a primary side (primary ports) of the solenoid proportional valves 45 (the first proportional valves 46 and the second proportional valves 47).

Therefore, the hydraulic fluid passage 32 can supply the hydraulic fluid flowing through the supply fluid passage 31 to each of the solenoid proportional valves 45 (the first proportional valves 46 and the second proportional valves 47). In other words, the fluid delivered from the second pump 22 is supplied to the solenoid proportional valves 45 through the supply fluid passage 31 and the hydraulic fluid passage 32.

In addition, as illustrated in FIG. 3, a first end portion of the drain fluid passage 33 is connected to the hydraulic fluid tank T, and a second end portion opposite to the first end portion is branched into a plurality of portions and connected to the solenoid proportional valve 45 and the directional switching valve 41.

Specifically, the second end portion of the drain fluid passage 33 is connected to a fluid passage between the delivery side port of the solenoid proportional valve 45 and the pressure receivers (the first pressure receiver 42 and the second pressure receiver 43) of the directional switching valve 41 and to a discharge port (a port for discharging the return oil from the hydraulic actuators AC) of the directional switching valve 41.

In addition, throttles 33b are provided at portions (discharge fluid passages 33a) of the drain fluid passage 33 that merge between ports on the secondary side (secondary ports) of the solenoid proportional valves 45 and the pressure receivers (the first pressure receivers 42 and the second pressure receivers 43) of the directional switching valves 41.

Thus, the drain fluid passage 33 enables a portion of the hydraulic fluid supplied from the solenoid proportional valves 45 to the pressure receivers (the first pressure receivers 42 and the second pressure receivers 43) of the directional switching valves 41 and the hydraulic fluid discharged from the directional switching valves 41 to be discharged to the hydraulic fluid tank T.

Consequently, each of the solenoid proportional valves 45 can change its opening in accordance with the magnitude of the current supplied thereto, so that the hydraulic fluid supplied from the hydraulic fluid passage 32 can be supplied to the pressure receivers (the first pressure receivers 42 and the second pressure receivers 43) of the directional switching valves 41 and can be discharged to the drain fluid passage 33. In other words, each of the solenoid proportional valves 45 is a valve that controls the corresponding hydraulic actuator AC through the directional switching valve 41 in accordance with the current supplied thereto.

Note that, although the present embodiment employs a configuration in which the three-position directional switching valves 41 are incorporated in the solenoid proportional valves 45, solenoid proportional valves for controlling the spools of the directional switching valves 41 may be provided separately from the directional control valves.

### Joystick Operation

As illustrated in FIG. 3, the hydraulic system HS of the working machine 1 includes a controller 70. The controller 70 is a device including an electric/electronic circuit, a program stored in a central processing unit (CPU), a microprocessor unit (MPU), or the like, and the like.

The controller 70 controls various devices included in the working machine 1. For example, the controller 70 can control the prime mover E1 and the rotational speed of the prime mover E1 (prime mover rotational speed). In addition, the controller 70 includes a storage unit 70a. The storage unit 70a is a non-volatile memory or the like and stores various types of information and the like relating to the control of the controller 70.

In each of the control valves V, the solenoids S1 and S2 of the first and second proportional valves 46 and 47, which are the solenoid proportional valves 45, are connected to the controller 70, and each of the solenoid proportional valves 45 receives the hydraulic fluid with a pilot pressure, the pilot pressure corresponding to the value of the current supplied as a command signal from the controller 70, that is, corresponding to a current value I, so as to switch the corresponding directional switching valve 41.

In addition, a first operation member 75 is connected to the controller 70. The operator manually operates the first operation member 75 in order to operate each of the directional switching valves 41.

The first operation member 75 includes a sensor 76 that detects an operation direction and an operation amount. The configuration of the sensor 76 is not particularly limited, and for example, a potentiometer or the like can be employed. The sensor 76 is connected to the controller 70 and outputs the detected operation direction and the detected operation amount as detection signals.

The controller 70 supplies a current having the current value I corresponding to the operation amount of the first operation member 75 to the solenoids S (S1, S2) of the solenoid proportional valves 45 of at least one of the control valves V to be operated. More specifically, as illustrated in FIG. 3, the controller 70 includes a current control unit 70b that controls (defines), in accordance with the operation direction and the operation amount of the first operation member 75, the current to be supplied to the solenoids S (S1, S2) of the solenoid proportional valves 45 of at least one of the control valves V to be operated.

The current control unit 70b is constituted by an electric/electronic component included in the controller 70, a program incorporated in the storage unit 70a, and the like.

The current control unit 70b defines the current (the current value I) to be supplied to the solenoids S (S1, S2) of each of the solenoid proportional valves 45 on the basis of a detection signal output by the sensor 76 to the controller 70 and on the basis of a control map or a predetermined arithmetic expression stored beforehand in the storage unit 70a. As a result, the controller 70 supplies the current defined by the current control unit 70b to the solenoids S (the first solenoid S1 or the second solenoid S2) of the solenoid proportional valves 45 (the first proportional valve 46 or the second proportional valve 47) of at least one of the control valves V to be operated.

Note that, as mentioned above, the current supplied by the controller 70 to the solenoids S (the first solenoid S1 or the second solenoid S2) of the solenoid proportional valves 45 (the first proportional valve 46 or the second proportional valve 47) of at least one of the control valves V to be operated has a dither amplitude.

In the present embodiment, the first operation member 75 includes a first operation actuator 75A and a second operation actuator 75B.

The first operation actuator 75A can operate two operation targets included in the working machine 1 and can operate, for example, the first switching valve 41A of the boom control valve V5 and the third switching valve 41C of the bucket control valve V7. In other words, the first operation actuator 75A can enable a swing operation of the boom 15 and a swing operation of the bucket 17.

The first operation actuator 75A includes, as the sensor 76, a first sensor 76a that detects an operation direction and an operation amount of the first operation actuator 75A. Thus, the current control unit 70b defines, on the basis of a detection signal output by the first sensor 76a, the current to be supplied to the solenoid S of each of the first solenoid valves 45A and the solenoid S of each of the third solenoid valves 45C, and the controller 70 supplies the current to the solenoid S of each of the first and third solenoid valves 45A and 45C.

For example, when the first operation actuator 75A is operated in either the front or rear direction, the current control unit 70b defines the current to be supplied to the solenoid S of each of the first solenoid valves 45A on the basis of a detection signal output by the first sensor 76a, and the controller 70 supplies the current to the solenoid S of each of the first solenoid valves 45A.

In contrast, when the first operation actuator 75A is operated in the machine-body width direction (in either the left or right direction), the current control unit 70b defines the current to be supplied to the solenoid S of each of the third solenoid valves 45C on the basis of the detection signal output by the first sensor 76a, and the controller 70 supplies the current to the solenoid S of each of the third solenoid valves 45C. As a result, the controller 70 controls the first switching valve 41A and the third switching valve 41C on the basis of the operation of the first operation actuator 75A.

The second operation actuator 75B can operate two operation targets included in the working machine 1 and can operate, for example, the second switching valve 41B of the arm control valve V6 and the fourth switching valve 41D of the turn control valve V8. In other words, the second operation actuator 75B can enable a swing operation of the arm 16 and can cause the slewing motor MT to be driven so as to turn.

The second operation actuator 75B includes, as the sensor 76, a second sensor 76b that detects an operation direction and an operation amount of the second operation actuator 75B. Thus, the current control unit 70b defines, on the basis of a detection signal output by the second sensor 76b, the current to be supplied to the solenoid S of each of the second solenoid valves 45B and the solenoid S of each of the fourth solenoid valves 45D, and the controller 70 supplies the current to the solenoid S of each of the second and fourth solenoid valves 45B and 45D.

For example, when the second operation actuator 75B is operated in either the front or rear direction, the current control unit 70b defines the current to be supplied to the solenoid S of each of the second solenoid valves 45B on the basis of a detection signal output by the second sensor 76b, and the controller 70 supplies the current to the solenoid S of each of the second solenoid valves 45B.

In contrast, when the second operation actuator 75B is operated in the machine-body width direction (in either the left or right direction), the current control unit 70b defines the current to be supplied to the solenoid S of each of the fourth solenoid valves 45D on the basis of the detection signal output by the second sensor 76b, and the controller 70 supplies the current to the solenoid S of each of the fourth solenoid valves 45D. As a result, the controller 70 controls the second switching valve 41B and the fourth switching valve 41D on the basis of the operation of the second operation actuator 75B.

Note that the first operation actuator 75A and the second operation actuator 75B are each constituted by, for example, an operation lever that is to be held and operated by the operator in the operator's seat 6. For example, these operation levers may be rotatable (swingable) in the front and rear directions and the machine-body width direction (the right and left directions) as mentioned above, and in addition, a joystick that is rotatable (swingable) in all directions from the neutral position may be used.

### Pilot Operation

The control valves V that are configured as the pilot-operated switching valves 51 and illustrated in FIG. 4 will be described below. These valves are the dozer control valve V1, the swing control valve V2, the first travel control valve V3, the second travel control valve V4, and the SP control valve V9, and they form a hydraulic circuit such as that illustrated in FIG. 4.

As illustrated in FIG. 4, an operation device 55 includes pilot valves 56 that supply the hydraulic fluid (a pilot fluid) with the pilot pressure to the control valves V (V1 to V4, V9) and second operation members 57 that operate the pilot valves 56. The second operation members 57 are constituted by, for example, an operation lever, a pedal, and the like arranged around the operator's seat 6.

The pilot-operated switching valves 51 as the control valves V are each switchable among a first position 51a, a second position 51b, and a neutral position 51c. Each of the pilot-operated switching valves 51 is urged so as to be at the neutral position 51c by an urging force of a neutral spring on the first side in switching directions and an urging force of another neutral spring on the second side opposite to the first side and is switched from the neutral position 51c to the first position 51a or the second position 51b by the pressure of the hydraulic fluid output from the pilot valves 56.

Each of the pilot-operated switching valves 51 include a third pressure receiver 52 on the first side in the switching directions and a fourth pressure receiver 53 on the second side in the switching directions. Ports on a primary side (primary ports) of the pilot valves 56 are connected to the second end portion of the hydraulic fluid passage 32, and the hydraulic fluid supplied from the hydraulic fluid passage 32 can be supplied from ports on a secondary side (secondary ports) of the pilot valves 56 to the pressure receivers (the third pressure receivers 52 and the fourth pressure receivers 53) of the pilot-operated switching valves 51.

Thus, when the hydraulic fluid supplied from one of the pilot valve 56 acts on a corresponding one of the third pressure receivers 52, the corresponding pilot-operated switching valve 51 is switched from the neutral position 51c to the first position 51a. When the hydraulic fluid supplied from the pilot valve 56 acts on the fourth pressure receiver 53, the pilot-operated switching valve 51 is switched from the neutral position 51c to the second position 51b. Thus, each of the pilot-operated switching valves 51 can switch the delivery (supply) amount (output) of the hydraulic fluid supplied from the delivery fluid passage 30 to the corresponding hydraulic actuator AC and the delivery (supply) direction of the hydraulic fluid.

Note that, in the hydraulic system HS of the working machine 1, at least one or more of the plurality of control valves V may include the solenoid proportional valves 45 incorporated therein, and the control valves V in which the solenoid proportional valves 45 are incorporated are not limited to the boom control valve V5, the arm control valve V6, the bucket control valve V7, and the turn control valve V8.

For example, the control valves V in which the solenoid proportional valves 45 are incorporated may be any of the dozer control valve V1, the swing control valve V2, the first travel control valve V3, the second travel control valve V4, and the SP control valve V9 and may be combinations thereof are not limited.

### Intermittent Standby Current

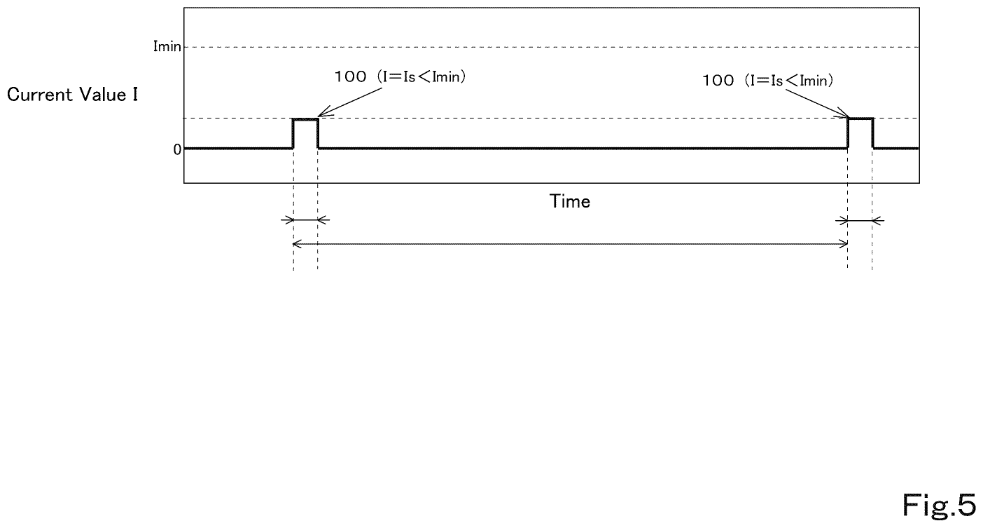

As illustrated in FIG. 5, in the hydraulic system HS of the working machine 1, the controller 70 intermittently supplies a standby current 100 having a predetermined current value Is to the solenoids S of the solenoid proportional valves 45 for changing the positions of the directional switching valves 41, each of which controls the corresponding hydraulic actuator AC. The controller 70 intermittently supplies the standby current 100 to one of the first proportional valves 46 and the second proportional valves 47 to which the pilot pressure for causing the corresponding directional switching valve 41 to perform the switching operation is not supplied.

For example, when one of the solenoid proportional valves 45 is switched to an operating position after being at the neutral position for a long time, the standby current 100 that is a weak current is supplied to the solenoid S of the solenoid proportional valve 45 in order to suppress a decrease in the reactivity of the solenoid proportional valve 45.

Therefore, the standby current 100 is supplied to the solenoid S of the solenoid proportional valve 45 during the period in which the solenoid proportional valve 45 is at the neutral position, so that when the first operation member 75 or the like is operated to move from the position at which the first operation member 75 or the like has been held, the solenoid proportional valve 45 favorably reacts to change the switching position of the directional switching valve 41.

As illustrated in FIG. 5, the standby current 100 is intermittently supplied to the solenoid proportional valve 45. In other words, the time over which the standby current 100 is supplied and the time over which the standby current 100 is not supplied are alternately repeated. As a result, the total value of the current used by the controller 70 is reduced compared with the case where the standby current 100 is continuously supplied, and an effect of suppressing heat generation of the controller 70 and an effect of reducing the power consumption are achieved.

As illustrated in FIG. 5, it is preferable to set the time over which the standby current 100 is not supplied to be longer and the time over which the standby current 100 is supplied to be shorter, and this can reduce the total value of the current supplied from the controller 70.

Note that each of these time periods may be set to any duration, and the time over which the standby current 100 is supplied may be longer than the time over which the standby current 100 is not supplied. Alternatively, the time over which the standby current 100 is supplied may be set to be approximately the same as the time over which the standby current 100 is not supplied.

In order to prevent malfunctions, or improper switching position changes, of the directional switching valves 41, the current value Is of the standby current 100 is set to be smaller than a minimum current value Imin of a shift current 101, which is required for activating the spool and which will be described later, and set within a range in which the directional switching valve 41 does not perform the switching operation. The current value Is is set to a value equal to or larger than the value of a minimum current for ensuring favorable reactivity of the spool.

In other words, the current value Is of the standby current 100 supplied to the solenoid proportional valve 45 is a current value that is set so as not to change the current position of the directional switching valve 41 while ensuring favorable reactivity that the solenoid proportional valve 45 is desired to have.

In the control valve unit CV in the present embodiment, each of the control valves V constitutes a single section, and the control valve unit CV is formed by combining a plurality of these sections. More specifically, the control valve unit CV includes a plurality of sections constituted by the solenoid proportional valves 45 including the directional switching valves 41 as illustrated in FIG. 3, and the control valve unit CV also includes sections constituted by the pilot-operated switching valves 51 as illustrated in FIG. 4. The above-described supply of the standby current 100 is applied to the sections that are constituted by the solenoid proportional valves 45 and that are illustrated in FIG. 3.

The first solenoids S1 of the first proportional valves 46 and the second solenoids S2 of the second proportional valves 47 each receives the current supplied from the controller 70, and they each supply the hydraulic fluid as the pilot pressure to the corresponding directional switching valve 41 in the same section (control valve V) so as to change the switching positions of the directional switching valve 41.

A current that is supplied to each of the first solenoids S1 of the first proportional valves 46 and the second solenoids S2 of the second proportional valves 47 in order to supply the pilot pressure (the hydraulic fluid) for causing each of the directional switching valves 41 to perform the switching operation (position change) will be referred to as the shift current 101. The value of the shift current 101 is equal to or larger than the above-mentioned minimum current value Imin.

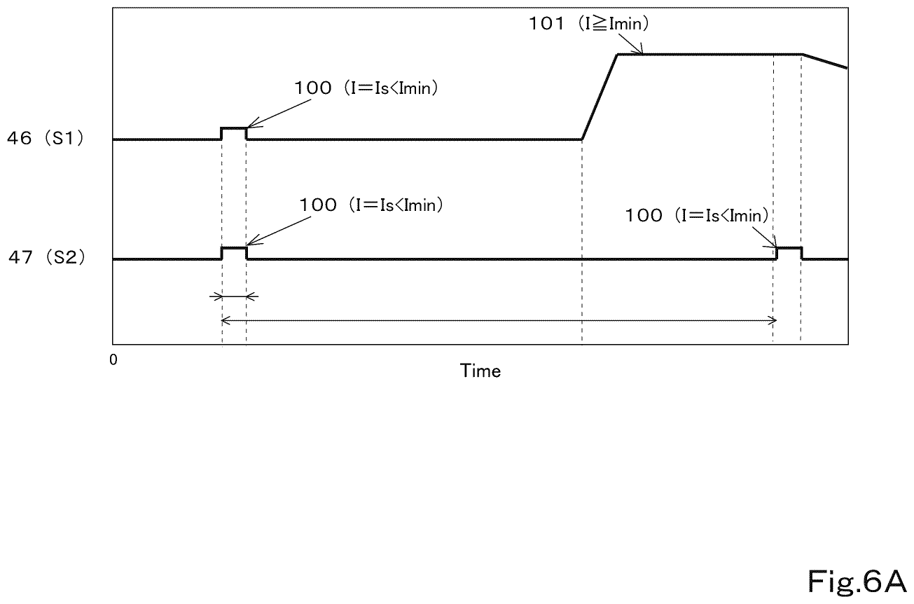

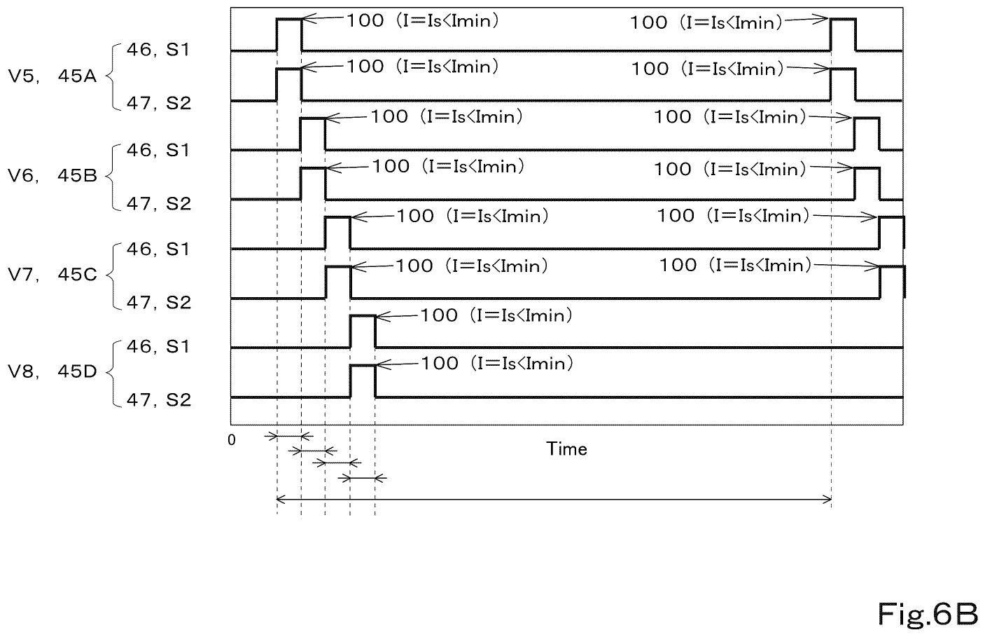

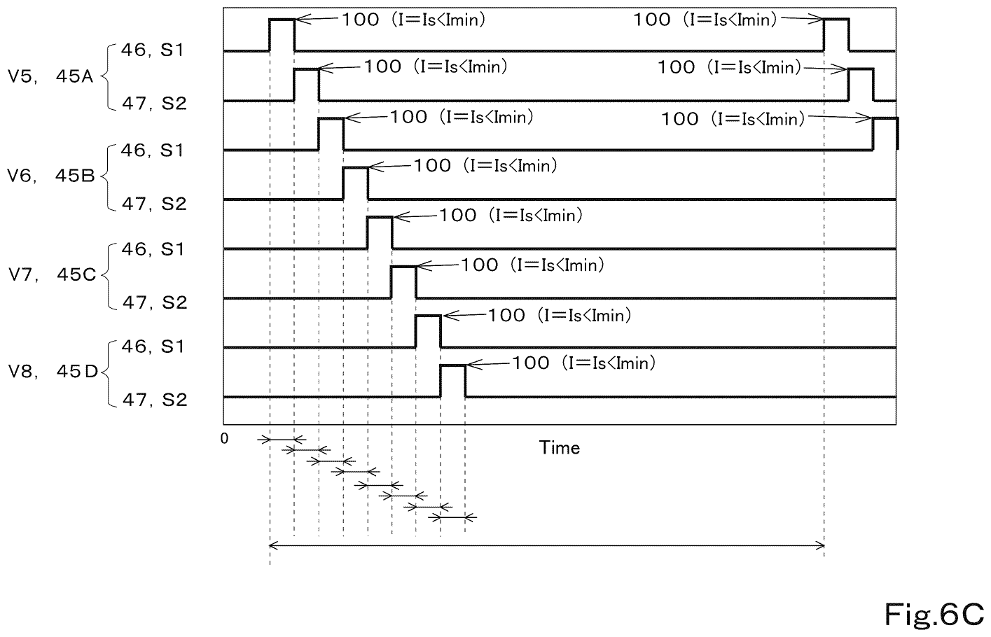

FIG. 6A illustrates an example of a pattern of supplying the standby current 100 to the first solenoid S1 (the first proportional valve 46) and to the second solenoid S2 (the second proportional valve 47) in each of the sections (each of the control valves V). When neither the first solenoid S1 (the first proportional valve 46) nor the second solenoid S2 (the second proportional valve 47) receives a current, the directional switching valve 41 is at the neutral position 41c. In this case, both the first solenoid S1 (the first proportional valve 46) and the second solenoid S2 (the second proportional valve 47) are intermittently supplied with the standby current 100.

Note that, in the pattern illustrated in 6A, the first solenoid S1 (the first proportional valve 46) and the second solenoid S2 (the second proportional valve 47) in the same section receive the standby current 100 simultaneously, and also, they receive the current for the same duration.

In the case of changing the switching positions of one of the directional switching valve 41 by supplying the shift current 101 to a corresponding one of the solenoid proportional valves 45 in the non-operating state in which neither the first solenoid S1 (the first proportional valve 46) nor the second solenoid S2 (the second proportional valve 47) receives the shift current 101, the shift current 101 is supplied to one of the first solenoid S1 (the first proportional valve 46) and the second solenoid S2 (the second proportional valve 47), and the other is not supplied with the shift current 101 but keeps receiving the intermittent supply of the standby current 100.

In the example illustrated in FIG. 6A, in order to switch the directional switching valve 41 from the neutral position 41c to the first position 41a, the shift current 101 is supplied to the first solenoid S1 (the first proportional control valve 46). Meanwhile, the standby current 100 is intermittently supplied to the second solenoid S2 (the second proportional valve 47) that is in the non-operating state without receiving the shift current 101.

Since the second solenoid S2 (the second proportional valve 47) has been maintained in the non-operating state before the shift current 101 is supplied to the first solenoid S1 (the first proportional valve 46), even during the period when the first solenoid S1 (the first proportional valve 46) receives the shift current 101, the second solenoid S2 (the second proportional valve 47) receives the standby current 100 after a predetermined period without current supply has elapsed since the timing at which it has received the previous supply of the standby current 100.

FIG. 6B and FIG. 6C each illustrate an example of a pattern of supplying the standby current 100 to the solenoid proportional valves 45 (45A, 45B, 45C, 45D) included in the plurality of control valves V in the control valve unit CV. In both of the examples, the standby current 100 is supplied to the solenoid proportional valves 45 (the solenoids S) of the plurality of control valves V at different timings.

As a result, compared with the case where the standby current 100 is supplied to the plurality of solenoid proportional valves 45 simultaneously, the total amount of current that is output at once by the controller 70 is reduced, contributing to an improvement in the durability of the controller 70.

In addition, in the embodiment illustrated in FIG. 6B, in each of the control valves V, when neither the first solenoid S1 nor the second solenoid S2 in the solenoid proportional valves 45 receives the shift current 101 for changing the position of the corresponding directional switching valve 41, that is, when neither the first proportional valve 46 nor the second proportional valve 47 supplies the pilot pressure for causing the directional switching valve 41 to perform the switching operation, the standby current 100 is supplied to the first solenoid S1 and the second solenoid S2 simultaneously.

This can simplify control of the timing for supplying the standby current 100, which is likely to become complex, as much as possible. In addition, the standby current 100 is supplied to the two ends of the spool of the directional switching valve 41 simultaneously, and thus, malfunctions of the directional switching valve 41 due to the standby current 100 can be reliably prevented from occurring.

In contrast, in the embodiment illustrated in FIG. 6C, in each of the control valves V, when neither the first solenoid S1 nor the second solenoid S2 in the solenoid proportional valves 45 receives the shift current 101 for changing the position of the corresponding directional switching valve 41, that is, when neither the first proportional valve 46 nor the second proportional valve 47 supplies the pilot pressure for causing the directional switching valve 41 to perform the switching operation, the standby current 100 is supplied to the first solenoid S1 and the second solenoid S2 at different timings from each other.

This can further enhance an effect of suppressing an increase in the total amount of current that is output at once by the controller 70.

### SECOND EMBODIMENT

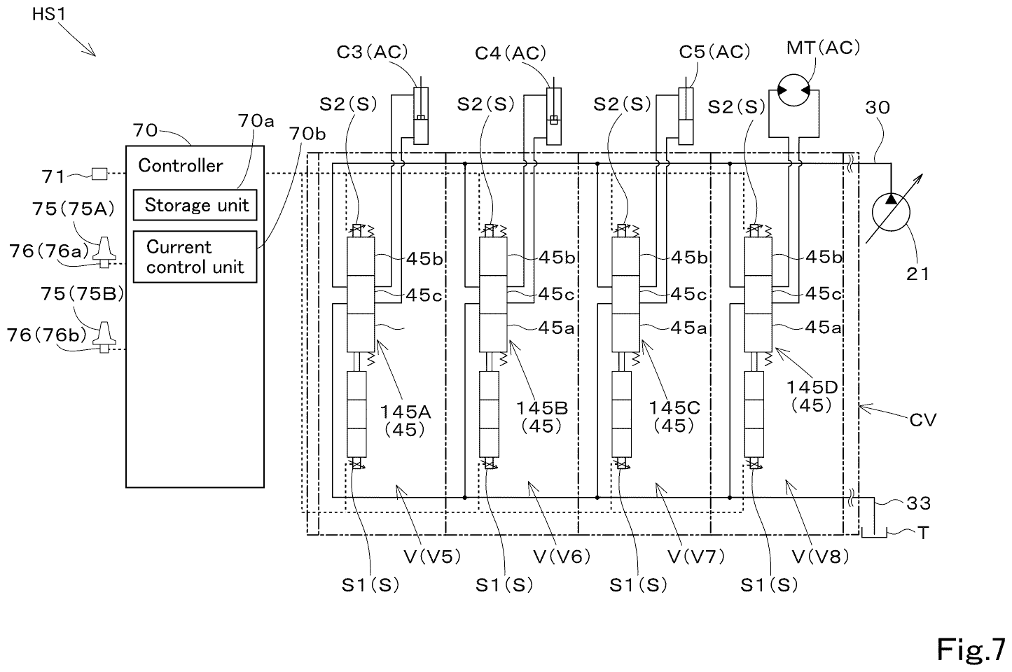

FIG. 7 illustrates a hydraulic system HS1 of a working machine according to another embodiment (second embodiment).

The hydraulic system HS1 of the working machine of the second embodiment will be described below focusing on a configuration different from that of the above-described embodiment (the first embodiment). Components that are common to the first embodiment will be denoted by the same reference signs, and detailed descriptions thereof will be omitted.

A difference between the hydraulic system HS1 of the second embodiment and the hydraulic system HS of the first embodiment is that the control valves V including the pilot-operated solenoid proportional valves 45 in the first embodiment are changed to those formed of direct-acting solenoid proportional valves 145.

### Description of Solenoid Proportional Valve

Each of the direct-acting solenoid proportional valves 145 is a valve in which a solenoid directly moves a spool without using a pilot valve so as to control the flow of the hydraulic fluid with respect to the corresponding hydraulic actuator AC.

In other words, in each of the solenoid proportional valves 145 illustrated in FIG. 7, the first solenoid S1 and the second solenoid S2 are arranged on the first side and the second side in the movement directions of the spool, respectively, without the proportional valves 46 and 47, such as those illustrated in FIG. 3. That is to say, the solenoids that act on movement of the spools of the solenoid proportional valves 145 (the directional switching valves 41) to the first side are the first solenoids S1, and the solenoids that act on movement of the spools to the second side are the second solenoids S2.

In the present embodiment, the solenoid proportional valve 145 that is included in the boom control valve V5 will be referred to as a first solenoid valve 145A, and the solenoid proportional valve 145 that is included in the arm control valve V6 will be referred to as a second solenoid valve 145B. The solenoid proportional valve 145 that is included in the bucket control valve V7 will be referred to as a third solenoid valves 145C, and the solenoid proportional valve 145 of the turn control valve V8 will be referred to as a fourth solenoid valve 145D. The term “solenoid proportional valves 145” represents a collective name for the first solenoid valve 145A to the fourth solenoid valve 145D.

Main valve portions of the solenoid proportional valves 145 illustrated in FIG. 7 are three-position switching-type directional switching valves like the directional switching valves 41. The position of each of the solenoid proportional valves 145 is switched between a neutral position 45c and a first position 45a or between the neutral position 45c and a second position 45b in response to movement of the corresponding spool due to supply of the shift current 101 to the corresponding first solenoid S1 or the corresponding second solenoid S2.

More specifically, when the shift current 101 is supplied to the first solenoid S1, the spool of the solenoid proportional valve 145 is moved by energization of the first solenoid S1, and the solenoid proportional valve 145 that has been at the neutral position 45c is switched to the first position 45a. In contrast, when the shift current 101 is supplied to the second solenoid S2, the spool of the solenoid proportional valve 145 is moved by energization of the second solenoid S2, and the solenoid proportional valve 145 that has been at the neutral position 45c is switched to the second position 45b.

A pattern of supplying the standby current 100 to the solenoids S1 and S2 of the solenoid proportional valves 145 illustrated in FIG. 7 and a pattern of supplying the standby current 100 to the plurality of solenoid proportional valves 145 (145A, 145B, 145C, 145D) are similar to the patterns of supplying the standby current 100 to the solenoid proportional valves 45 in the first embodiment. In other words, the patterns of intermittently supplying the standby current 100, which have been described with reference to FIG. 5, FIG. 6A, FIG. 6B, and FIG. 6C are employed.

### Advantageous Effects

The above-described hydraulic system HS (HS1) of the working machine includes the hydraulic actuators AC that are driven by the hydraulic fluid, the control valves V each of which performs the switching operation for switching the flow rate of the hydraulic fluid supplied to the corresponding hydraulic actuator AC, and the controller 70 that controls the control valves V. The control valves V include the solenoids S and perform the switching operation in accordance with the current supplied to the solenoids S. The controller 70 supplies, to the solenoids S, the shift current 101 for causing the control valves V to perform the switching operation, and when the shift current 101 is not supplied, the controller 70 intermittently supplies the standby current 100 having the current value Is, which is smaller than the shift current 101 and which is within the range in which the control valves V do not perform the switching operation.

According to the above-described configurations, a situation in which supply of the current to the solenoids S of the control valves V stops for a long period of time will not occur. This can solve a problem where, when the supply of the current to the solenoids S of the control valves V stops for a long period of time, start of the operations of the control valves V in response to the current supplied again is delayed.

The hydraulic system HS (HS1) configured as described above includes the plurality of hydraulic actuators AC and the plurality of control valves V each of which corresponds to one of the plurality of hydraulic actuators AC. The controller 70 supplies the standby current 100 to the solenoids S of the plurality of control valves V at different timings.

According to the above-described configuration, the controller 70 does not supply the standby current 100 to the plurality of control valves V simultaneously, and thus, the load caused by supplying the standby current 100 can be reduced.

In addition, in the hydraulic system HS configured as described above, the control valves V include the directional switching valves 41 and the solenoid proportional valves 45. The directional switching valves 41 switch the flow rate of the hydraulic fluid supplied to the hydraulic actuators AC. The solenoid proportional valves 45 include the solenoids S that cause, in response to the shift current 101, the directional switching valves 41 to operate.

According to the above-described configuration, the above-described advantageous effect obtained by the intermittent supply of the standby current 100 to the solenoids S can be achieved in the pilot-operated solenoid proportional valves 45.

In addition, in the hydraulic system HS (HS1) configured as described above, the solenoids S of the control valves V include the first solenoids S1 that act on switching of the control valves V to the first side and the second solenoids S2 that act on switching of the control valves V to the second side. The controller 70 intermittently supplies the standby current 100 to at least one of the first solenoids S1 and the second solenoids S2 that is not supplied with the shift current 101.

According to the above-described configuration, the controller 70 supplies the standby current 100, so that at least one of the solenoids S1 or at least one of the solenoids S2 that is not supplied with the shift current 101 can exhibit improved response when it receives the shift current 101 at a later time. On the other hand, the controller 70 does not supply the standby current 100 to at least one of the solenoids S1 or at least one of the solenoids S2 that is supplied with the shift current 101, and thus, the likelihood of unintended operation of the corresponding hydraulic actuator AC can be reduced with higher certainty.

In addition, in the hydraulic system HS (HS1) configured as described above, the controller 70 supplies the standby current 100 to the first solenoid S1 and the second solenoid S2 in each of the control valves V simultaneously when neither the first solenoid S1 nor the second solenoid S2 is not supplied with the shift current 101.

According to the above configuration, control of the timing for supplying the standby current 100, which is likely to become complex, can be simplified as much as possible.

Alternatively, in the hydraulic system HS (HS1) configured as described above, the controller 70 supplies the standby current 100 to the first solenoid S1 and the second solenoid S2 in each of the control valves V at different timings when neither the first solenoid S1 nor the second solenoid S2 is not supplied with the shift current 101.

According to the above-described configuration, the controller 70 does not supply the standby current 100 to the first solenoid S1 and the second solenoid S2 simultaneously, and thus, the load caused by supplying the standby current 100 can be reduced.

In the hydraulic system HS configured as described above, each of the control valves V includes the directional switching valve 41 and the solenoid proportional valves 45. The directional switching valve 41 includes the first pressure receiver 42 and the second pressure receiver 43 and performs the switching operation in accordance with the pilot pressure acting on the first pressure receiver 42 and the second pressure receiver 43. The solenoid proportional valves 45 include the first proportional valve 46, which controls the pilot pressure acting on the first pressure receiver 42 by operation of the first solenoid S1, and the second proportional valve 47, which controls the pilot pressure acting on the second pressure receiver by operation of the second solenoid S2. The controller 70 intermittently supplies the standby current 100 to one of the first proportional valve 46 and the second proportional valve 47 that does not supply the pilot pressure for causing the directional switching valve 41 to perform the switching operation.

According to the above-described configuration, the above-described advantageous effect obtained by the intermittent supply of the standby current 100 to the first solenoid S1 and the second solenoid S2 can be achieved in the first proportional valve 46 and the second proportional valve 47, which are pilot-operated solenoid proportional valves.

The working machine 1 includes the hydraulic system HS (HS1) configured as described above.

According to the above-described configuration, the above-described advantageous effect obtained by the intermittent supply of the standby current 100 can be achieved in the working machine 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A hydraulic system of a working machine, comprising:
a hydraulic actuator to be driven by a hydraulic fluid;
a control valve to perform a switching operation for switching a flow rate of a hydraulic fluid supplied to the hydraulic actuator; and
a controller to control the control valve, wherein
the control valve includes a solenoid and performs the switching operation in accordance with a current supplied to the solenoid, and
the controller supplies, to the solenoid, a shift current for causing the control valve to perform the switching operation and intermittently supplies a standby current when the shift current is not supplied, the standby current having a current value smaller than the shift current and within a range in which the control valve does not perform the switching operation.

2. The hydraulic system of a working machine according to claim 1, comprising:
a plurality of the hydraulic actuators; and
a plurality of the control valves each corresponding to one of the plurality of hydraulic actuators, wherein
the controller supplies the standby current to a plurality of the solenoids of the plurality of control valves at different timings.

3. The hydraulic system of a working machine according to claim 1, wherein
the control valve includes a directional switching valve to switch a flow rate of a hydraulic fluid supplied to the hydraulic actuator and a solenoid proportional valve including the solenoid, the solenoid being configured to cause, in accordance with the shift current, the directional switching valve to operate.

4. The hydraulic system of a working machine according to claim 1, wherein
the solenoid of the control valve includes a first solenoid to act on switching of the control valve to one side and a second solenoid to act on switching of the control valve to another side, and
the controller intermittently supplies the standby current to one of the first solenoid and the second solenoid that is not supplied with the shift current.

5. The hydraulic system of a working machine according to claim 4, wherein
the controller supplies the standby current to the first solenoid and the second solenoid in the control valve simultaneously when neither the first solenoid nor the second solenoid is supplied with the shift current.

6. The hydraulic system of a working machine according to claim 4, wherein
the controller supplies the standby current to the first solenoid and the second solenoid in the control valve at different timings when neither the first solenoid nor the second solenoid is supplied with the shift current.

7. The hydraulic system of a working machine according to claim 4, wherein the control valve includes
a directional switching valve including a first pressure receiver and a second pressure receiver, the directional switching valve being configured to perform the switching operation in accordance with a pilot pressure acting on the first pressure receiver and the second pressure receiver, and
a solenoid proportional valve including a first proportional valve to control, by operation of the first solenoid, a pilot pressure acting on the first pressure receiver and a second proportional valve to control, by operation of the second solenoid, a pilot pressure acting on the second pressure receiver, and
the controller intermittently supplies the standby current to one of the first proportional valve and the second proportional valve that does not supply a pilot pressure for causing the directional switching valve to perform the switching operation.

8. A working machine comprising the hydraulic system according to claim 1.
